(19) United States
(12) Patent Application Publication
(10) Pub. No.: US 2016/0064939 A1
(43) Pub. Date: Mar. 3, 2016

(54) USING POWER OVER ETHERNET PROTOCOL TO AUGMENT A DC/AC POWER MODULE INVERTER AND APPLICATION THEREOF

(71) Applicant: WEN-HSIEN LAI, Taoyuan Hsien (TW)

(72) Inventor: WEN-HSIEN LAI, Taoyuan Hsien (TW)

(73) Assignee: IN WIN DEVELOPMENT, INC., Taoyuan Hsien (TW)

(21) Appl. No.: 14/470,057

(22) Filed: Aug. 27, 2014

(51) Int. Cl. H02J 4/00

(52) U.S. Cl. CPC H02J 4/00

(57) ABSTRACT

The present invention uses the power over ethernet protocol to augment a DC/AC power module inverter with application thereof, in which the original power over ethernet protocol is used as the basis for a DC power supply, and augments an ethernet powered device module with a DC-AC module inverter, thereby forming a device having two different output applications that is equivalent to a module having both a DC to DC and DC to AC at the same time.

### BACKGROUND OF THE INVENTION

(a) Field of the Invention

The present invention relates to using power over ethernet to augment a DC/AC (direct current/alternating current) power module inverter and application thereof, and more particularly to a POE (Power Over Ethernet) respectively providing the DC output from a PSE (Power Source Equipment) to a computer unit DC power equipment and other AC power equipment via integration of a DC/AC and a DC/DC module inverter.

(b) Description of the Prior Art

It is known that POE (Power Over Ethernet) is a technology for transmitting power and data to a device through a twisted pair wire in the Ethernet. Devices including internet telephones, wireless access points, web cameras, hubs, computers, and the like, can be supplied with power by the POE technology. As the electronic equipment powered by the Ethernet can be used without requiring an additional power socket, the time and money spent in configuring the power cable can be saved, thereby reducing the cost of the entire device.

Nevertheless, existing electronic equipment powered by POE technology are seldom used in computer systems. However, the continuous advancement of current CPUs on motherboards and North/South bridge chips have significantly reduced the amount of electricity required, thus, the problems of using POE applications in computers have been greatly reduced.

In effect, building a completely compliant POE involves a PSE (Power Source Equipment) providing power that is transmitted to a network PD (Powered Device) module using a RJ-45 (registered jack-45) network cable circuit. Wherein the PD module converts 57 volts to 19 volts for use by connected equipment.

### SUMMARY OF THE INVENTION

Accordingly, the primary object of the present invention is to use a POE (Power Over Ethernet) to directly couple one proportion of the DC voltage output from a PSE (Power Source Equipment) to a DC power equipment, such as a computer unit DC power equipment, and couple another proportion of the DC voltage output to an AC power equipment, such as a computer monitor or other peripheral equipment via a DC to AC module inverter.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a circuit block diagram according to a power system of the present invention.

FIG. 2 shows a circuit block diagram according to a PD (Powered Device) module of the present invention.

### DETAILED DESCRIPTION OF THE PREFERRED EMBODIMENTS

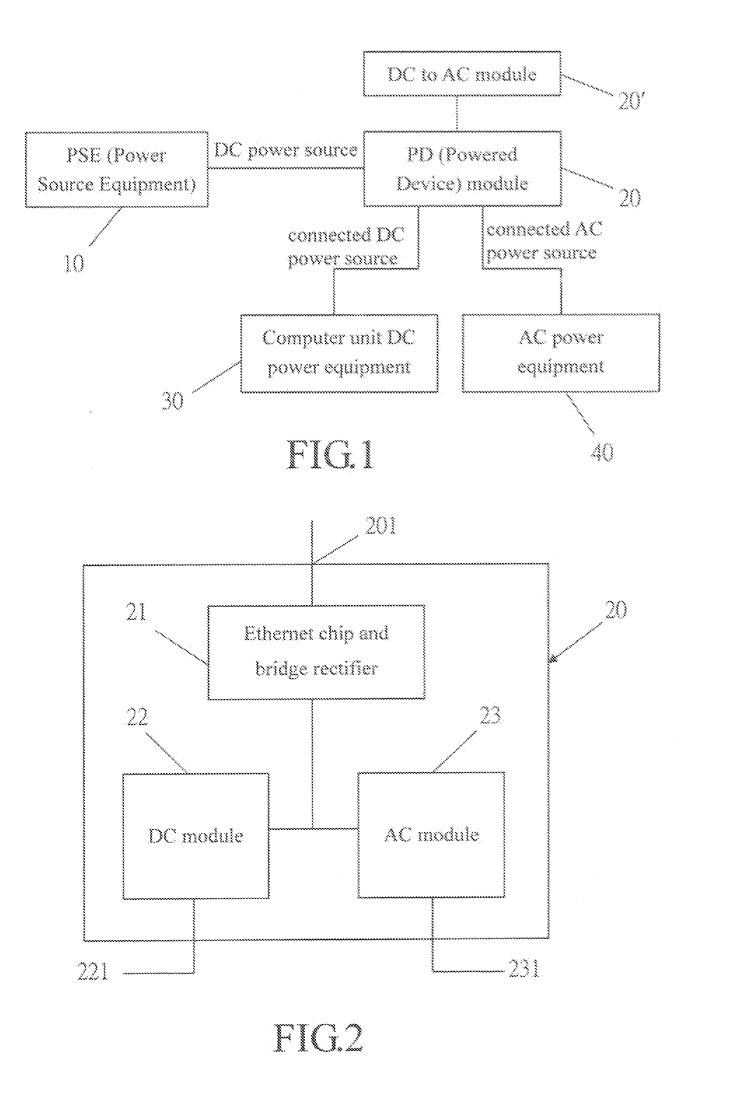

Referring to FIG. 1, which shows a circuit block diagram according to a power system of the present invention, wherein the power source of the present invention is a PSE (Power Source Equipment) 10. The voltage from the PSE 10 is DC (direct current) voltage, with a DC output power that is generally from 42˜57 volts. The DC voltage output from the PSE 10 is connected to a PD (Powered Device) module 20 via a normal CAT 5e (Category) network cable. Input power to the PD module 20 is DC. A power supply module interface of the PD module 20 is attached to an appropriate POE (Power Over Ethernet). One proportion of the DC voltage from the PD module 20 is output as DC voltage to a computer unit DC power equipment 30, and another proportion of the AC voltage output is output to an AC power equipment 40 via a DC/AC (alternating current) module inverter. A DC to AC module 20′ is built to a PD module 20.

The power output amount can be dynamically adjusted according to the known power input, and, in effect, is according to the computer system or monitor connected to the output power source.

Referring to FIG. 2, which shows a circuit block diagram according to the PD module 20 of the present invention, wherein a POE DC voltage 201 is input into the PD module 20 and enters a POE interface and bridge rectifier 21. The PD module 20 is provided with the standard POE interface and bridge rectifier 21 according to the requirements of the various types of POE or implementation. The POE couples the DC voltage 201 to a DC module 22 or an AC module 23 via the bridge rectifier 21. The DC module 22 converts the input voltage from the bridge rectifier 21 to DC voltage, and then outputs DC voltage 221 to a DC power equipment. The DC module 22 to an AC module 23 converts the input voltage from the bridge rectifier 21 to DC voltage, and then outputs AC voltage 231 to an AC power source equipment. The DC to AC module 23 converts the input voltage to DC voltage by itself.

In conclusion, according to the above description of the embodiments, the present invention provides a POE, and a PD module couples the DC voltage from the PSE to a computer unit DC power equipment with DC voltage. In addition, the PD module can couple the DC voltage from the PSE to an AC power equipment via a DC to AC module inverter.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. Using power over ethernet protocol to augment a DC/AC power module inverter and application thereof, wherein direct current (DC) output from a power over ethernet power source equipment (PSE) is coupled to an ethernet powered device module, and the DC voltage output is coupled to a DC module or the DC voltage output is coupled to an AC (alternating current) module via an ethernet chip and bridge rectifier in the interior of the ethernet powered device module to respectively provide DC voltage to a DC power equipment or DC voltage from the DC voltage to an AC module inverter to an AC power equipment.

2. The using power over ethernet protocol to augment a DC/AC power module inverter and application thereof according to claim 1, wherein the DC power equipment is a computer unit DC power equipment.

3. The using power over ethernet protocol to augment a DC/AC power module inverter and application thereof according to claim 1, wherein the AC power equipment is a computer monitor or other peripheral equipment.
